(19) United States
(12) Patent Application Publication
(10) Pub. No.: US 2009/0046452 A1
(43) Pub. Date: Feb. 19, 2009

(54) Disposable gas lighter with advertising flashlight

(75) Inventors: Xinhua Huang, Ningbo (CN); Zhi Hu, Ningbo (CN); Huanyun Zhang, Ningbo (CN)

Correspondence Address: Canhui Song, PMB 601, 1750-1 30th Street, Boulder, CO, 80301, US

(73) Assignee: Xinhua Huang

(21) Appl. No.: 11/889,532

(22) Filed: Aug. 14, 2007

(51) Int. Cl. F23Q 7/14; F21L 4/00

(52) U.S. Cl. 362/205

(57) ABSTRACT

A disposable gas lighter with advertising flashlight. The lighter has a flashlight unit having a power source, a lamp electrically connected to the power source, a push-button switch to turn on the lamp when pressed down, a sleeve installed in a recess of the body which contains the lamp in one end thereof, a film bearing advertising information and placed in around a middle portion of the sleeve, and a convex contained in a free end of the sleeve. The convex is located in an opening defined on the surface of the body. When the push-button switch is pressed down, the flashlight unit is able to give off a light beam. When the beam meets a plane in front of the gas lighter, a project of the film comes into being. Viewers then are able to watch the advertising information of the film with the project.

### BACKGROUND OF THE INVENTION

1. Field of the Invention

The invention relates to a disposable gas lighter having a built-in flashlight that is able to form a project for advertising information on a plane in front of the gas lighter when a push-button switch thereof is depressed.

2. Description of the Prior Art

Methods for advertising on disposable gas lighters have long been developed. However, novel way to advertise that is able to attract more attention is still needed. The U.S. Pat. No. 4,816,971 and naming “Flashlight with Built-in Lighter” disclosed a “portable flashlight for illumination and for cigarette lighting.” It is thought that it will be advantageous if the flashlight is either able to be used as an advertising approach.

### BRIEF SUMMARY OF THE INVENTION

The main object of the invention is to provide a disposable gas lighter with advertising flashlight which is able to both illuminate and form a project for advertising information on a plane in front of the flashlight.

In order to accomplish the aforementioned objects, the present invention provides a disposable gas lighter with advertising flashlight. The lighter has a flashlight unit having a power source, a lamp electrically connected to the power source, a push-button switch to turn on the lamp when pressed down, a sleeve installed in a recess of the body which contains the lamp in one end thereof, a film bearing advertising information and placed in around a middle portion of the sleeve, and a convex contained in a free end of the sleeve. The convex is located in an opening defined on the surface of the body. When the push-button switch is pressed down, the flashlight unit is able to give off a light beam. When the beam meets a plane in front of the gas lighter, a project of the film comes into being. Viewers then are able to watch the advertising information of the film with the project.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the gas lighter of the invention. And,

FIG. 2 is a partially cross-sectional view of the gas lighter shown in FIG. 1.

### DETAILED DESCRIPTION OF THE PREFERRED EMBODIMENT

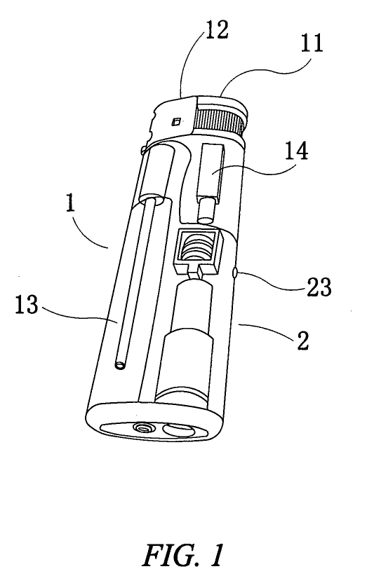

Shown in FIG. 1 is a disposable gas lighter having a built-in advertising flashlight. The gas lighter has body 1 having a fuel-storage chamber 13 for containing liquefied gaseous fuel, an upliftable gas release nozzle (not shown) mounted on the fuel-storage chamber 13, a piezoelectric unit 14 securely mounted in the fuel-storage chamber 13 and having a piezoelectric button which when pressed downward, is able to startup the piezoelectric unit 14 to generate sparks for ignition, a pair of pillars securely mounted on the fuel-storage chamber 13, an ignition trigger 11 which when pressed down, slidable with respect to the pillars and when released, resumable to its undepressed position, a linkage (not shown) rotatably mounted on the fuel-storage chamber 13 which when the ignition trigger 11 is pressed down, is able to uplift the gas release nozzle to release the gaseous fuel and at the same time depress the piezoelectric button to startup the piezoelectric unit 14 to generate sparks, a flame cover 12 installed on the fuel-storage chamber 13 and fixed to the pair of pillars, and, a flashlight unit 2. The gas release nozzle is so positioned that the gaseous fuel being released is easy able to be ignited by the sparks generated from the piezoelectric unit 14.

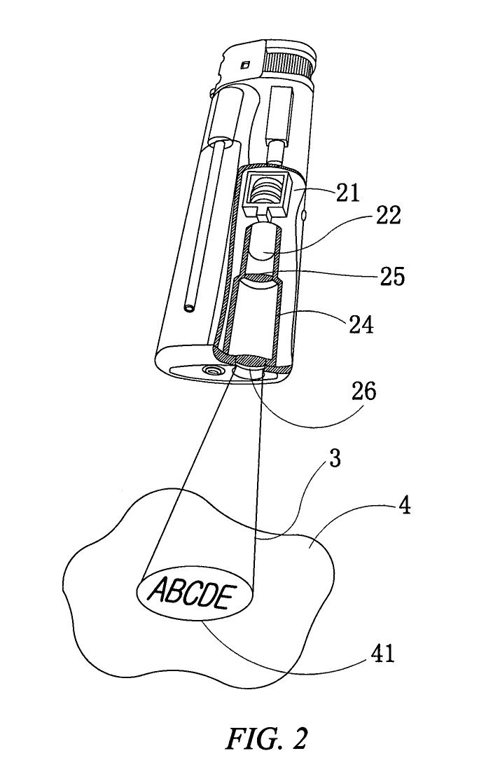

With reference to FIGS. 1 and 2, the flashlight unit 2 has a power source 21, a lamp 22 electrically connected to the power source 21, a push-button switch 23 to turn on the lamp 22 when pressed down, a sleeve 24 installed in a recess of the body 1 which contains the lamp 22 in one end thereof, a film 25 bearing advertising information and placed in around a middle portion of the sleeve 24, and a convex 26 contained in a free end of the sleeve 24. The convex 26 is located in an opening defined on the surface of the body 1.

In use, a user of the gas lighter is able to press down the push-button switch 23 and the flashlight unit is then able to give off a light beam 3. When the beam 3 meets a plane 4 in front of the gas lighter, a project 41 of the film 25 comes into being. Viewers then are able to watch the advertising information of the film 25 with the project 41.

From above description, it is seen that the objects of the present invention have been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

What is claimed is:

1. A disposable gas lighter with advertising flashlight having a flashlight unit having a power source, a lamp electrically connected to said power source, a push-button switch to turn on said lamp when pressed down, a sleeve which contains said lamp in one end thereof, a film bearing advertising information and placed in around a middle portion of said sleeve, and a convex contained in a free end of said sleeve.
